(19) United States
(12) Patent Application Publication
(10) Pub. No.: US 2008/0278398 A1
(43) Pub. Date: Nov. 13, 2008

(54) Antenna Device with a Parasitic Coupler

(75) Inventors: Taio-Hsing TSAI, Yungho City (TW); Chieh-Ping CHIU, Er Lun Hsiang (TW); Chih-Wei LIAO, Yilan Shien (TW)

Correspondence Address: BANNER & WITCOFF, LTD., 1100 13th STREET, N.W., SUITE 1200, WASHINGTON, DC, 20005-4051, US

(73) Assignee: QUANTA COMPUTER INC., Kuei Shan Hsiang (TW)

(21) Appl. No.: 11/867,153

(22) Filed: Oct. 4, 2007

(30) Foreign Application Priority Data
May 7, 2007 (TW) 096116107

(51) Int. Cl. H01Q 1/50

(52) U.S. Cl. 343/850

(57) ABSTRACT

An antenna device includes an antenna, a parasitic coupler, and a conductive strip. The antenna is operable within a first frequency bandwidth. The parasitic coupler is spaced apart from said antenna, and is electromagnetically coupled to the antenna so as to be operable within a second frequency bandwidth. The conductive strip is connected to the grounding elements of the antenna and the parasitic coupler.

### CROSS-REFERENCE TO RELATED APPLICATION

This application claims priority of Taiwanese application no. 096116107, filed on May 7, 2007.

### BACKGROUND OF THE INVENTION

1. Field of the Invention

This invention relates to an antenna device, more particularly to an antenna device with a parasitic coupler.

2. Description of the Related Art

FIG. 1 illustrates a conventional antenna device 1 for wireless networking applications mounted in a notebook computer 100.

The notebook computer 100 includes a lower housing 101, a keyboard 102 mounted on the lower housing 101, an upper housing 103 coupled pivotably to the lower housing 101, a liquid crystal display (LCD) 104 mounted on the upper housing 103, and a grounding plate 105 mounted in the upper housing 103.

The conventional antenna device 1 includes a planar inverted-F antenna (PIFA) 10, a conductive strip 11, and a pair of securing members 16. The PIFA 10 includes a radiating unit, a grounding element 12, and a feeding element 15. The radiating unit includes a left radiating element 13 that is operable within the 2.4 GHz frequency bandwidth, and a right radiating element 14 that is operable within the 5.0 GHz bandwidth. The grounding element 12 has an upper end connected to a junction of the left and right radiating elements 13, 14. The feeding element 15 has an upper end connected to the left radiating element 13. The conductive strip 11 is connected to the grounding plate 105 of the notebook computer 100, and has left and right end portions 111, 112, and an intermediate portion 113 that interconnects the left and right end portions 111, 112 thereof. The grounding element 12 has a lower end connected to the intermediate portion 113 of the conductive strip 11. Each of the securing members 16 is connected to a respective one of the left and right end portions 111, 112 of the conductive strip 11 and is formed with a hole 161 therethrough. The conventional antenna device 1 is secured to the upper housing 103 of the notebook computer 100 with the use of a pair of screws (not shown). Each of the screws is inserted through the hole 161 in a respective one of the securing members 16 and is threadedly engaged to the upper housing 103 of the notebook computer 100.

The aforementioned conventional antenna device 1 is disadvantageous in that, since the securing members 16 are connected to the grounding plate 105 of the notebook computer 100 through the conductive strip 11, the securing members 16 undesirably affect the radiation efficiency and impedance bandwidth of each of the left and right radiating elements 13, 14 of the radiating unit.

To solve this problem, it has been proposed, in another conventional antenna device, to lengthen the conductive strip so as to dispose the securing members away from the left and right radiating elements. This, however, can cause other problems. That is, not only does an additional space need to be made available within the upper housing of the notebook computer, but the structure of the conventional antenna device is also weakened.

### SUMMARY OF THE INVENTION

Therefore, the object of the present invention is to provide an antenna device that can overcome the aforesaid drawbacks of the prior art.

According to the present invention, an antenna device comprises an antenna, a parasitic coupler, and a conductive strip.

The antenna is operable within a first frequency bandwidth, and includes a radiating element, a grounding element, and a feeding element. The radiating element of the antenna has left and right end portions, and an intermediate portion that interconnects the left and right end portions thereof. The grounding element of the antenna has upper and lower ends. The upper end of the grounding element of the antenna is connected to the left end portion of the radiating element. The feeding element of the antenna is connected to the intermediate portion of the radiating element.

The parasitic coupler is spaced apart from the antenna, is electromagnetically coupled to the antenna so as to be operable within a second frequency bandwidth different from the first frequency bandwidth, and includes a coupling element and a grounding element. The coupling element of the parasitic coupler has left and right end portions, and an intermediate portion that interconnects the left and right end portions thereof. The grounding element of the parasitic coupler has upper and lower ends. The upper end of the grounding element of the parasitic coupler is connected to the right end portion of the coupling element.

The conductive strip has a left end connected to the lower end of the grounding element of the antenna, and a right end connected to the lower end of the grounding element of the parasitic coupler.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view to illustrate a conventional antenna device mounted in a notebook computer;

FIG. 2 is a schematic view of the first preferred embodiment of an antenna device according to this invention;

FIG. 3 is a perspective view illustrating the first preferred embodiment mounted in a notebook computer;

FIG. 4 is a plot illustrating a voltage standing wave ratio of the first preferred embodiment;

FIG. 5 shows plots of radiation patterns of the antenna of the first preferred embodiment respectively on the x-y, x-z, and y-z planes when operated at 2.437 GHz;

FIG. 6 shows plots of radiation patterns of the parasitic coupler of the first preferred embodiment respectively on the x-y, x-z, and y-z planes when operated at 5.470 GHz;

FIGS. 7 and 8 are schematic views illustrating modified embodiments of the first preferred embodiment according to this invention;

FIG. 9 is a schematic view of the second preferred embodiment of an antenna device according to this invention;

FIG. 10 is a schematic view illustrating a modified embodiment of the second preferred embodiment according to this invention;

FIG. 11 is a schematic view of the third preferred embodiment of an antenna device according to this invention;

FIG. 12 is a schematic view illustrating a modified embodiment of the third preferred embodiment according to this invention;

FIG. 13 is a schematic view of the fourth preferred embodiment of an antenna device according to this invention;

FIG. 14 is a schematic view illustrating a modified embodiment of the fourth preferred embodiment according to this invention; and

FIG. 15 is a schematic view of the fifth preferred embodiment of an antenna device according to this invention.

### DETAILED DESCRIPTION OF THE PREFERRED EMBODIMENTS

Before the present invention is described in greater detail, it should be noted that like elements are denoted by the same reference numerals throughout the disclosure.

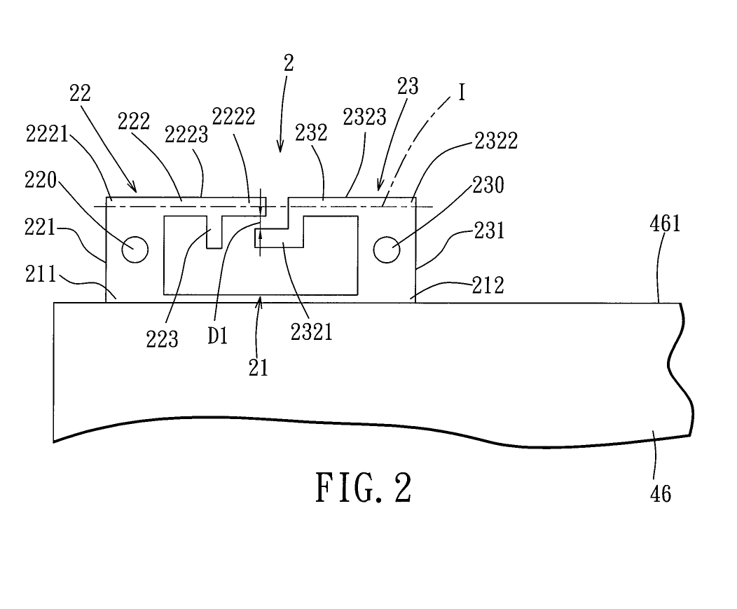

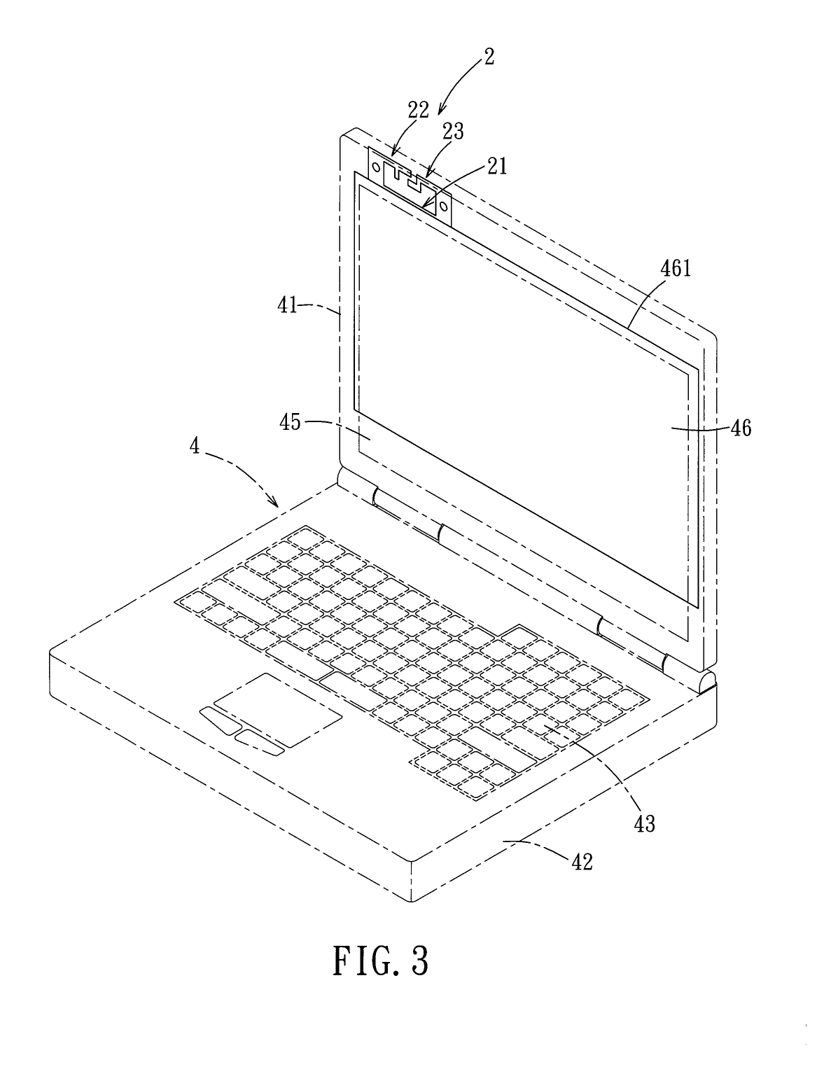

Referring to FIGS. 2 and 3, the first preferred embodiment of an antenna device 2 according to this invention is shown to include an antenna 22, a parasitic coupler 23, and a conductive strip 21.

The antenna device 2 of this embodiment is suitable for wireless networking applications, such as a wireless local area network (WLAN) or a wireless wide area network (WWAN).

The antenna device 2 is mounted in an electronic device 4, such as a notebook computer, is a dual-band antenna device, and is operable within a first frequency bandwidth, and within a second frequency bandwidth different from the first frequency bandwidth.

In this embodiment, the first frequency bandwidth is the 2.4 GHz bandwidth, and the second frequency bandwidth is the 5.0 GHz bandwidth. In an alternative embodiment, the first frequency bandwidth is the 5.0 GHz bandwidth, and the second frequency bandwidth is the 2.4 GHz bandwidth.

The electronic device 4 has a lower housing 42, a keyboard 43 mounted on the lower housing 42, an upper housing 41 coupled pivotably to the lower housing 42, a liquid crystal display (LCD) 45 mounted on the upper housing 41, a grounding plate 46 mounted in the upper housing 41, and a signal source (not shown) mounted in the upper housing 41.

The antenna 22 is operable within the first frequency bandwidth, i.e., the 2.4 GHz bandwidth, is a planar inverted-F antenna (PIFA), and includes a radiating element 222, a grounding element 221, and a feeding element 223. The radiating element 222 of the antenna 22 has left and right end portions 2221, 2222, and an intermediate portion 2223 that interconnects the left and right endportions 2221, 2222 thereof. The grounding element 221 of the antenna 22 has an upper end connected to the left end portion 2221 of the radiating element 222. The feeding element 223 of the antenna 22 has an upper end connected to the intermediate portion 2223 of the radiating element 222, and a lower end connected to the signal source. In this embodiment, the left and right end portions 2221, 2222 and the intermediate portion 2223 of the radiating element 222 have the same width.

The parasitic coupler 23 is spaced apart from the antenna 22, is electromagnetically coupled to the radiating element 222 of the antenna 22 so as to be operable within the second frequency bandwidth, i.e., the 5.0 Ghz bandwidth, and includes a coupling element 232 and a grounding element 231. The coupling element 232 of the parasitic coupler 23 has left and right end portions 2321, 2322, and an intermediate portion 2323 that interconnects the left and right end portions 2321, 2322 thereof. The grounding element 231 of the parasitic coupler 23 has an upper end connected to the right end portion 2322 of the coupling element 232 of the parasitic coupler 23.

The conductive strip 21 is connected to an upper edge 461 of the grounding plate 46 of the electronic device 4, and has a left end 211 connected to a lower end of the grounding element 221 of the antenna 22, and a right end 212 connected to a lower end of the grounding element 231 of the parasitic coupler 23.

In this embodiment, each of the left and right end portions 2221, 2222 and the intermediate portion 2223 of the radiating element 222 and the right end portion 2322 and the intermediate portion 2323 of the coupling element 232 lies on an imaginary straight line (I). The left end portion 2321 of the coupling element 232 is generally L-shaped, and includes a first leg that extends transversely from the intermediate portion 2323 of the coupling element 232 toward the conductive strip 21, and a second leg that is disposed below the right end portion 2222 of the radiating element 222. The right end portion 2222 of the radiating element 222 and the second leg of the left end portion 2321 of the coupling element 232 define a vertical distance (D1) therebetween that ranges from 0.5 millimeters to 3.0 millimeters.

It is noted herein that the electromagnetic coupling between the radiating element 222 of the antenna 22 and the parasitic coupler 23 may be increased or decreased, for the purpose of impedance matching, by simply adjusting the vertical distance (D1).

The antenna device 2 of this invention is secured to the upper housing 41 of the electronic device 4 with the use of a pair of screws (not shown). In particular, the grounding element 221, 231 of each of the antenna 22 and the parasitic coupler 23 is formed with a hole 220, 230 therethrough. Each of the screws may be inserted through the hole 220, 230 in the grounding element 221, 231 of a respective one of the antenna 22 and the parasitic coupler 23 and threadedly engaged to the upper housing 41 of the electronic device 4.

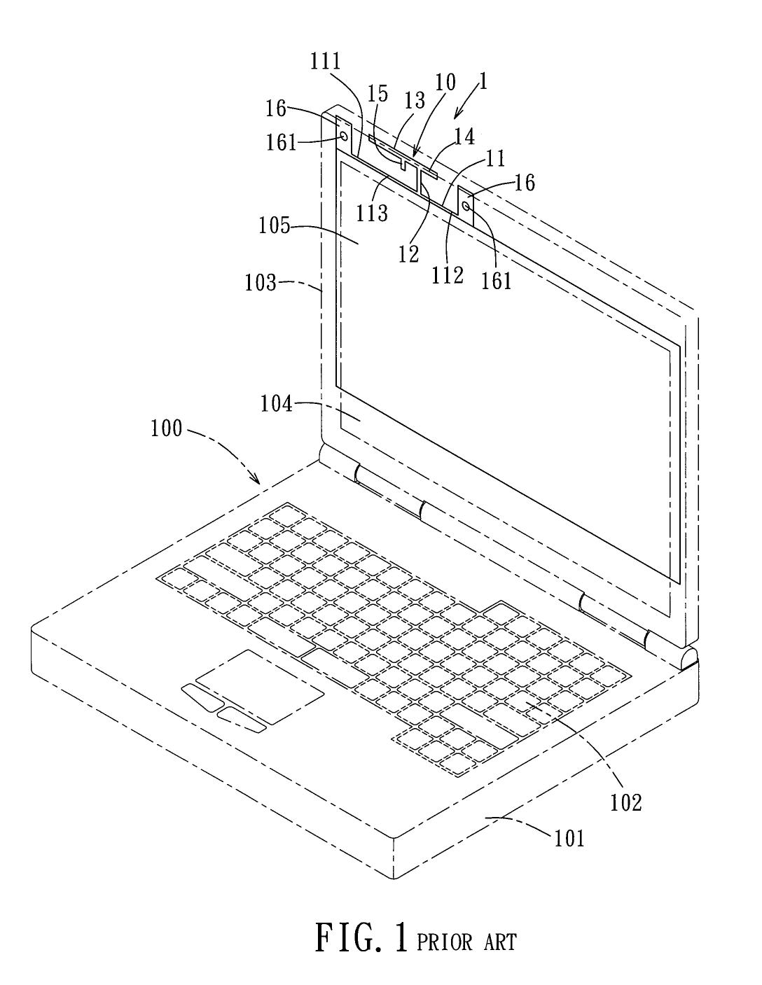

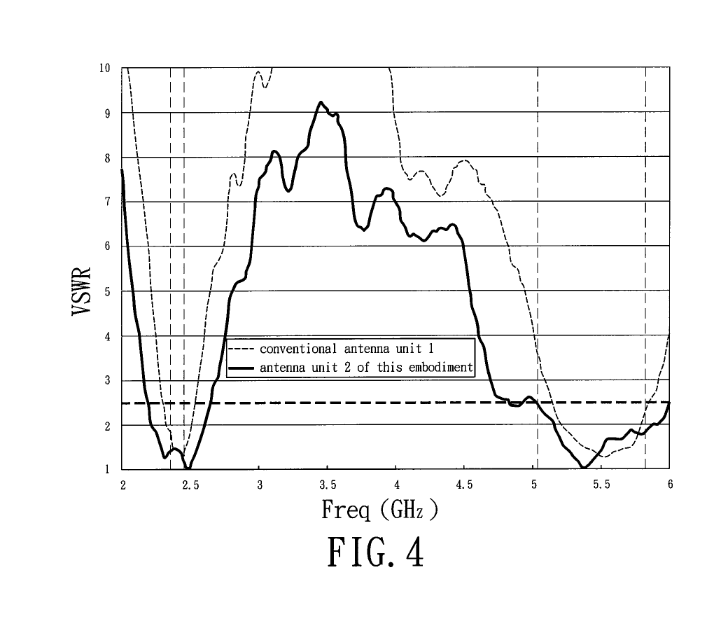

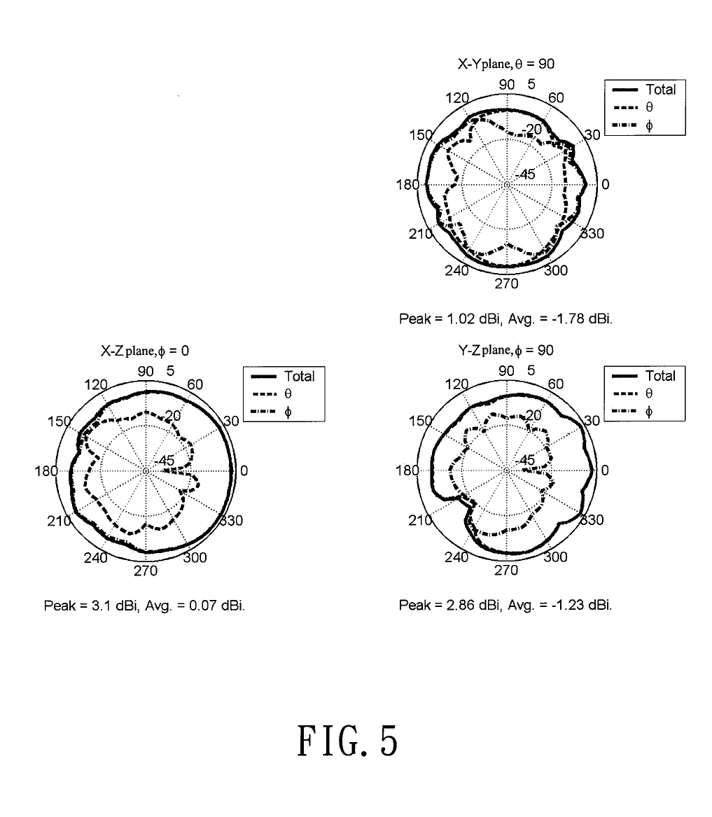

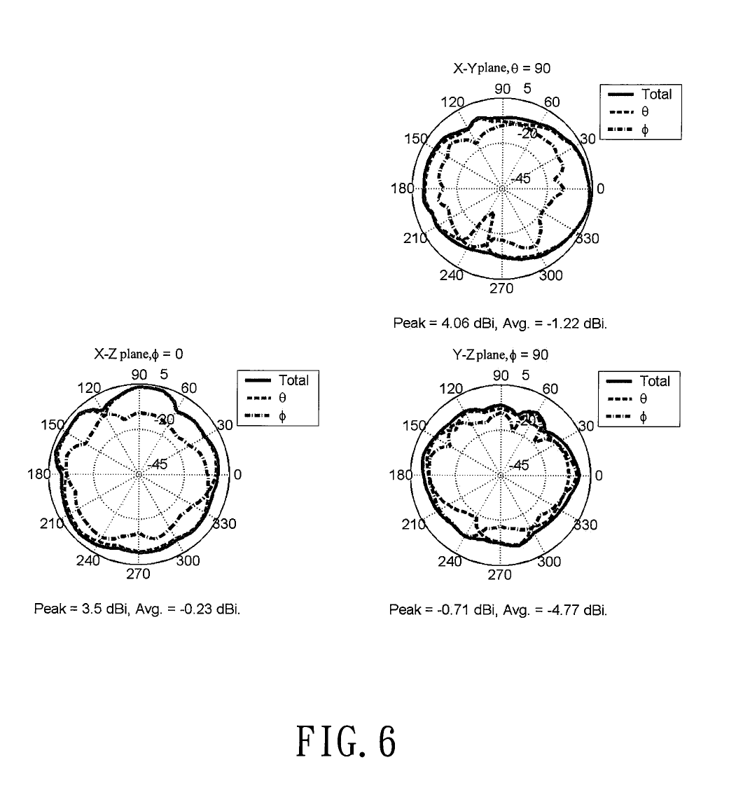

Based on experimental results, as illustrated in FIG. 4, when compared to the conventional antenna device 1 (see FIG. 1), the antenna device 2 of this embodiment achieves a lower voltage standing wave ratio (VSWR) of less than 2.5, and wider first and second frequency bandwidths. In addition, as shown in Table I, when compared to the conventional antenna device 1, the antenna device 2 of this embodiment, when operated within 2.412 GHz and 2.462 GHz and within 5.150 GHz and 5.785 GHz, achieves higher total radiation powers and radiation efficiencies. Moreover, as illustrated in FIG. 5, the antenna 22 of the antenna device 2 of this embodiment has substantially omnidirectional radiation patterns when operated within the 2.437 GHz bandwidth. Further, as illustrated in FIG. 6, the parasitic coupler 23 of the antenna device 2 of this embodiment has substantially omnidirectional radiation patterns when operated within the 5.470 GHz bandwidth. Hence, the antenna device 2 of this invention is indeed suitable for WLAN and WWAN applications.

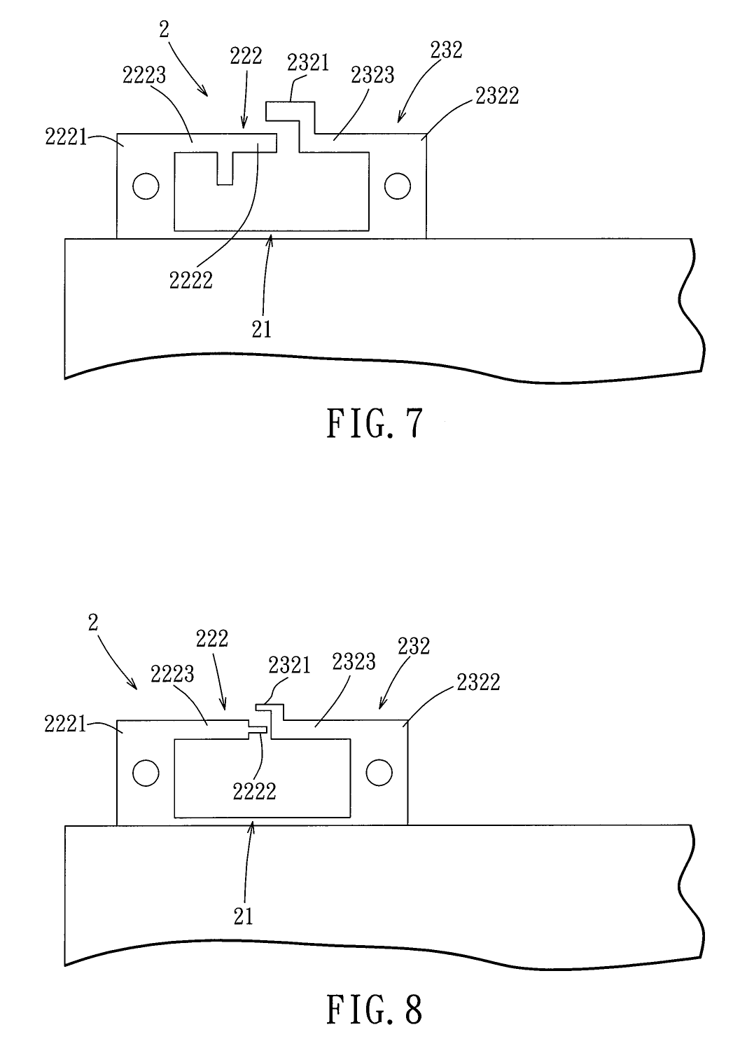

FIG. 7 illustrates a modified embodiment of the first preferred embodiment according to this invention. In this embodiment, the first leg of the left end portion 2321 of the coupling element 232 extends transversely from the intermediate portion 2323 of the coupling element 232 away from the conductive strip 21. The second leg of the left end portion 2321 of the coupling element 232 is disposed above the right end portion 2222 of the radiating element 222.

In another modified embodiment of the first preferred embodiment, as illustrated in FIG. 8, the right end portion 2222 of the radiating element 222 has a width that is narrower than those of the left end portion 2221 and the intermediate portion 2223 of the radiating element 222.

TABLE I

| Antenna device 2 of | | | | | |
|---|---|---|---|---|---|
| this embodiment | | | Conventional antenna device 1 | | |
| | | Radiation | | | Radiation |
| Frequency | TRP | Efficiency | Frequency | TRP | Efficiency |
| (GHz) | (dB) | (%) | (GHz) | (dB) | (%) |
| 2.412 | −1.8 | 66.1 | 2.412 | −2.5 | 56.9 |
| 2.437 | −1.6 | 69.3 | 2.437 | −2.0 | 62.4 |
| 2.462 | −1.4 | 72.9 | 2.462 | −1.7 | 67.8 |
| 5.150 | −2.7 | 53.7 | 5.150 | −3.3 | 47.1 |
| 5.350 | −1.5 | 71.4 | 5.350 | −1.9 | 65.1 |
| 5.470 | −1.8 | 65.6 | 5.470 | −2.1 | 61.9 |
| 5.725 | −1.3 | 74.4 | 5.725 | −1.6 | 69.2 |
| 5.785 | −2.0 | 62.9 | 5.785 | −2.2 | 59.7 |

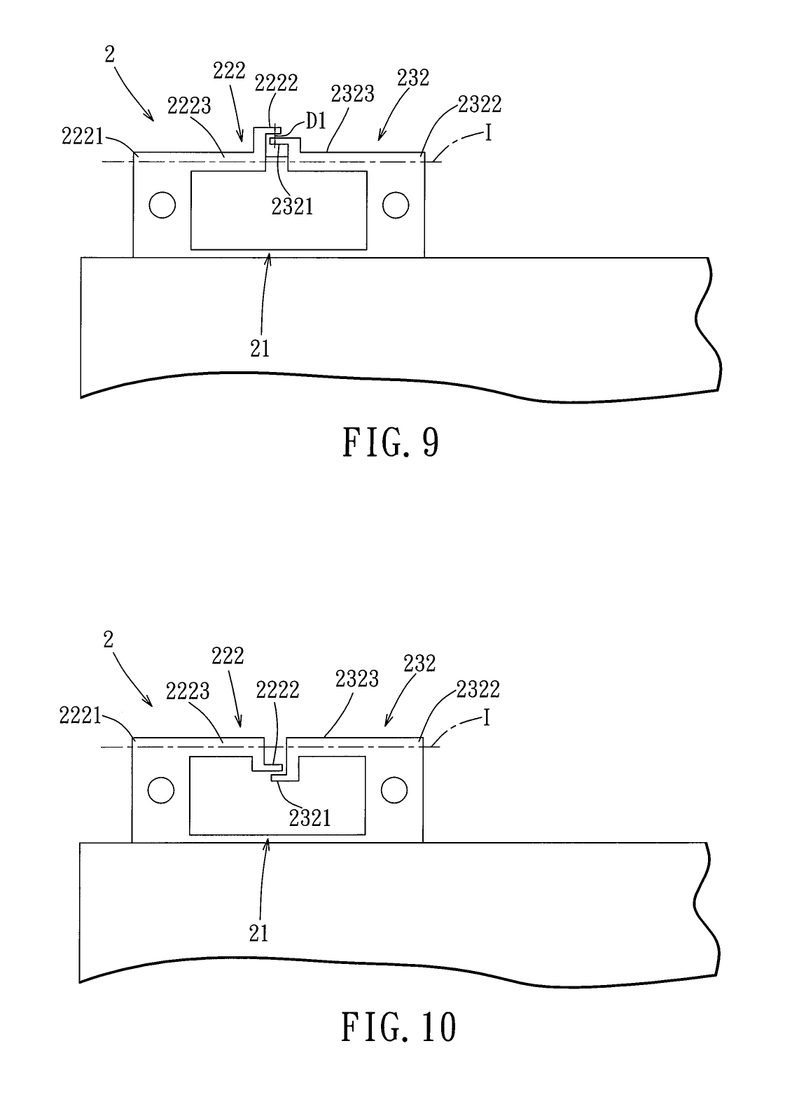

FIG. 9 illustrates the second preferred embodiment of an antenna device 2 according to this invention. When compared to the first preferred embodiment, each of the left end portion 2221 and the intermediate portion 2223 of the radiating element 222 and the right end portion 2322 and the intermediate portion 2323 of the coupling element 232 lies on the imaginary straight line (I).

The right end portion 2222 of the radiating element 222 is generally L-shaped, and includes a first leg that extends transversely from the intermediate portion 2223 of the radiating element 222 away from the conductive strip 21, and a second leg that is disposed above the imaginary straight line (I). The first leg of the left end portion 2321 of the coupling element 232 extends transversely from the intermediate portion 2323 of the coupling element 232 away from the conductive strip 21. The second leg of the left end portion 2321 of the coupling element 232 is disposed below the second leg of the right end portion 2222 of the radiating element 222.

The second leg of the right end portion 2222 of the radiating element 222 and the second leg of the left end portion 2321 of the coupling element 232 define a vertical distance (D1) therebetween that ranges from 0.5 millimeters to 3.0 millimeters.

FIG. 10 illustrates a modified embodiment of the second preferred embodiment according to this invention. In this embodiment, the first leg of the right end portion 2222 of the radiating element 222 extends transversely from the intermediate portion 2223 of the radiating element 222 toward the conductive strip 21. The second leg of the right end portion 2222 of the radiating element 222 is disposed below the imaginary straight line (I). The first leg of the left end portion 2321 of the coupling element 232 extends transversely from the intermediate portion 2323 of the coupling element 232 toward the conductive strip 21. The second leg of the left end portion 2321 of the coupling element 232 is disposed below the second leg of the right end portion 2222 of the radiating element 222.

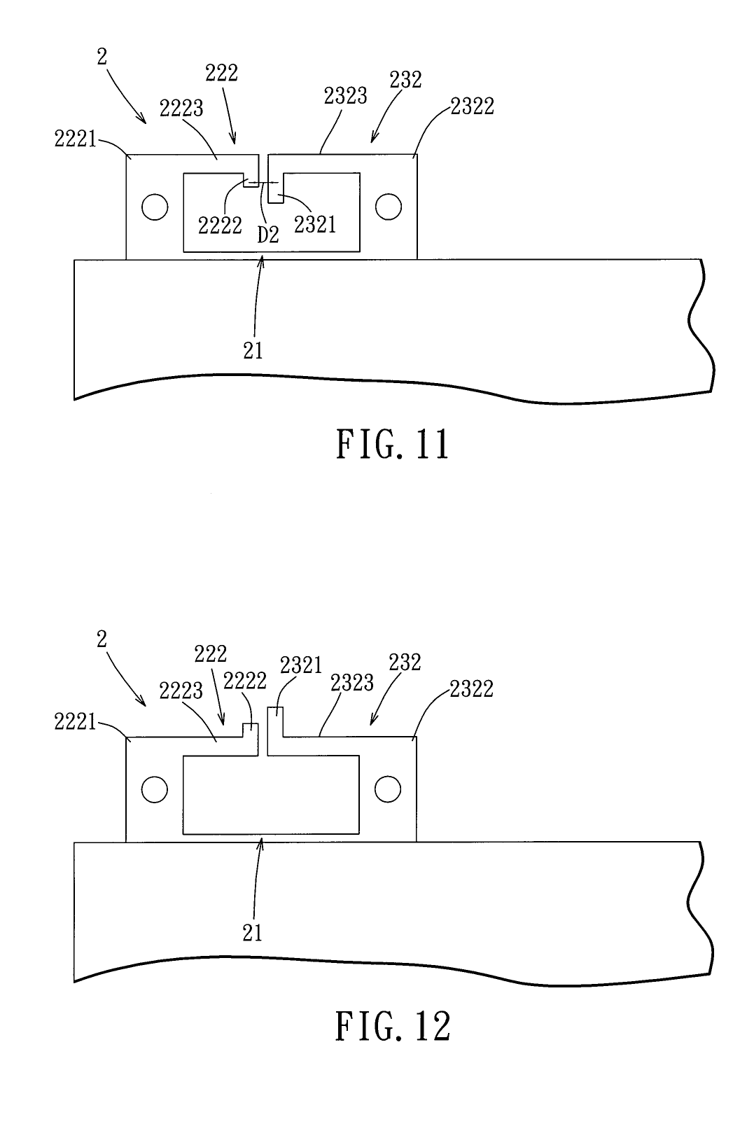

FIG. 11 illustrates the third preferred embodiment of an antenna device 2 according to this invention. When compared to the second embodiment, the right end portion 2222 of the radiating element 222 extends transversely from the intermediate portion 2223 of the radiating element 222 toward the conductive strip 21.

The left end portion 2321 of the coupling element 232 extends transversely from the intermediate portion 2323 of the coupling element 232 toward the conductive strip 21.

The right end portion 2222 of the radiating element 222 and the left end portion 2321 of the coupling element 232 define a horizontal distance (D2) therebetween that ranges from 0.5 millimeters to 3.0 millimeters.

FIG. 12 illustrates a modified embodiment of the third embodiment according to this invention. In this embodiment, the right end portion 2222 of the radiating element 222 extends transversely from the intermediate portion 2223 of the radiating element 222 away from the conductive strip 21.

The left end portion 2321 of the coupling element 232 extends transversely from the intermediate portion 2323 of the coupling element 232 away from the conductive strip 21.

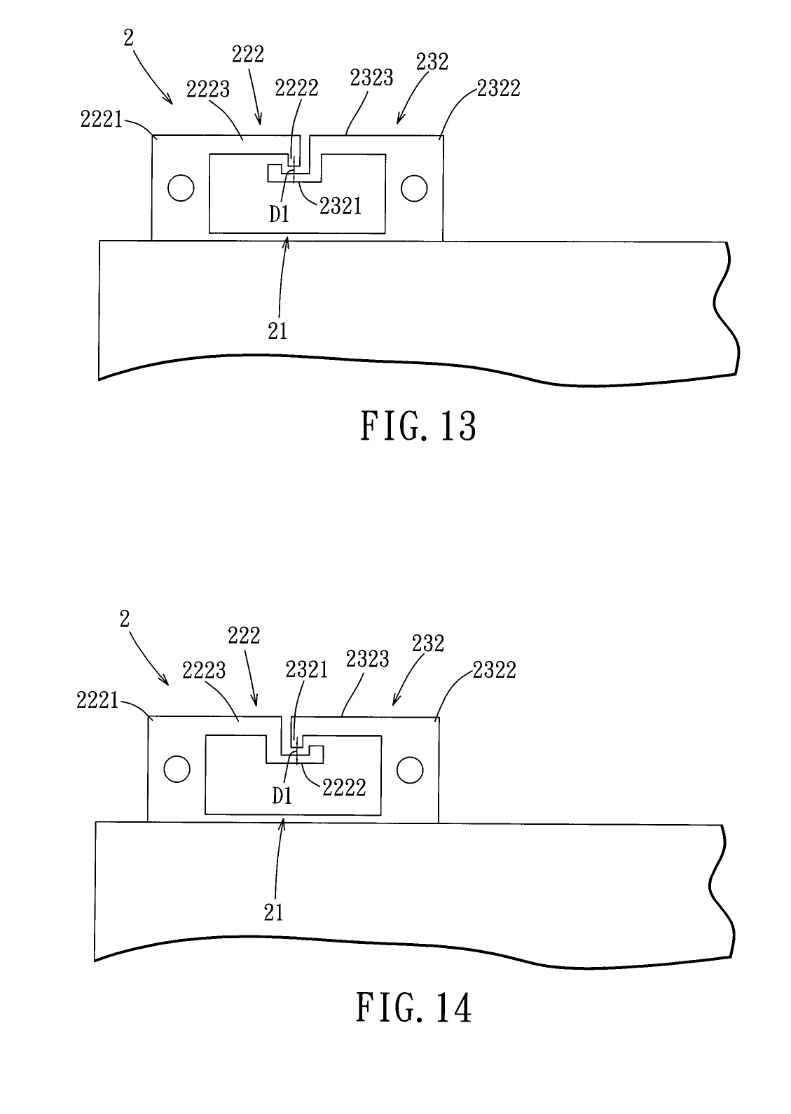

FIG. 13 illustrates the fourth preferred embodiment of an antenna device 2 according to this invention. When compared to the second embodiment, the first leg of the left end portion 2321 of the coupling element 232 extends transversely from the intermediate portion 2323 of the coupling element 232 toward the conductive strip 21. The second leg of the left end portion 2321 of the coupling element 232 is generally hook-shaped and defines a recess. The right end portion 2222 of the radiating element 222 extends transversely from the intermediate portion 2223 of the radiating element 222 toward the conductive strip 21 into the recess in the second leg of the left end portion 2321 of the coupling element 232.

The right end portion 2222 of the radiating element 222 and the second leg of the left end portion 2321 of the coupling element 232 define a vertical distance (D1) therebetween that ranges from 0.5 millimeters to 3.0 millimeters.

FIG. 14 illustrates a modified embodiment of the fourth embodiment according to this invention. When compared to the second embodiment, the first leg of the right end portion 2222 of the radiating element 222 extends transversely from the intermediate portion 2223 of the radiating element 222 toward the conductive strip 21. The second leg of the right end portion 2222 of the radiating element 222 is generally hook-shaped and defines a recess. The left end portion 2321 of the coupling element 232 extends transversely from the intermediate portion 2323 of the coupling element 232 toward the conductive strip 21 into the recess in the second leg of the second end portion 2222 of the radiating element 222.

The left end portion 2321 of the coupling element 232 and the second leg of the right end portion 222 of the radiating element 222 define a vertical distance (D1) therebetween that ranges from 0.5 millimeters to 3.0 millimeters.

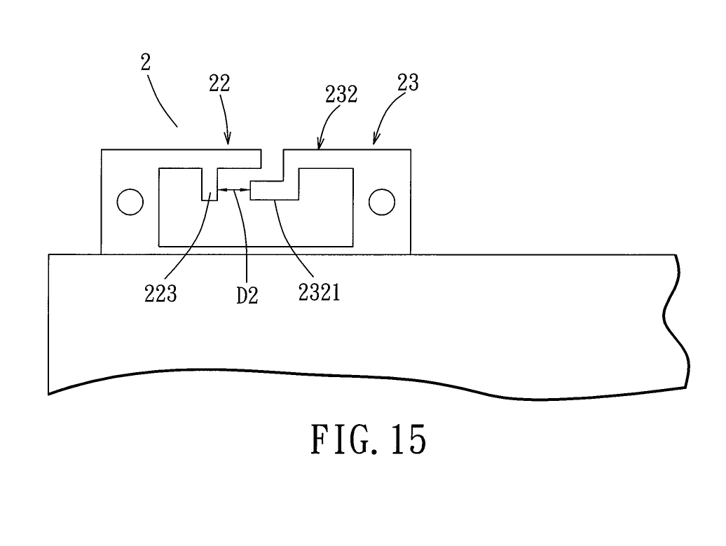

FIG. 15 illustrates the fifth preferred embodiment of an antenna device 2 according to this invention. When compared to the first preferred embodiment, the parasitic coupler 23 is electromagnetically coupled to the feeding element 223 of the antenna 22 so as to be operable within the second frequency bandwidth, i.e., 5.0 GHz bandwidth.

The feeding element 223 and the second leg of the left end portion 2321 of the coupling element 232 define a horizontal distance (D2) therebetween that ranges from 0.5 millimeters to 3.0 millimeters.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An antenna device, comprising:
an antenna operable within a first frequency bandwidth, said antenna including
a radiating element that has left and right end portions, and an intermediate portion interconnecting said left and right end portions thereof,
a grounding element that has upper and lower ends, said upper end of said grounding element of said antenna being connected to said left end portion of said radiating element, and
a feeding element that is connected to said intermediate portion of said radiating element;
a parasitic coupler spaced apart from said antenna, and electromagnetically coupled to said antenna so as to be operable within a second frequency bandwidth different from the first frequency bandwidth, said parasitic coupler including
a coupling element that has left and right end portions, and an intermediate portion interconnecting said left and right end portions thereof, and
a grounding element that has upper and lower ends, said upper end of said grounding element of said parasitic coupler being connected to said right end portion of said coupling element; and
a conductive strip having a left end connected to said lower end of said grounding element of said antenna, and a right end connected to said lower end of said grounding element of said parasitic coupler.

2. The antenna device as claimed in claim 1, wherein each of said left and right end portions and said intermediate portion of said radiating element and said right end portion and said intermediate portion of said coupling element lies on an imaginary straight line.

3. The antenna device as claimed in claim 2, wherein said left end portion of said coupling element is generally L-shaped, and includes a first leg that extends transversely from said intermediate portion of said coupling element toward said conductive strip, and a second leg that is disposed below said right end portion of said radiating element.

4. The antenna device as claimed in claim 3, wherein said right end portion of said radiating element and said second leg of said left end portion of said coupling element define a vertical distance therebetween that ranges from 0.5 millimeters to 3.0 millimeters.

5. The antenna device as claimed in claim 1, wherein said grounding element of each of said antenna and said parasitic coupler is formed with a hole therethrough.

6. The antenna device as claimed in claim 2, wherein said left end portion of said coupling element is generally L-shaped, and includes a first leg that extends transversely from said intermediate portion of said coupling element away from said conductive strip, and a second leg that is disposed above said right end portion of said radiating element.

7. The antenna device as claimed in claim 1, wherein each of said left end portion and said intermediate portion of said radiating element and said right end portion and said intermediate portion of said coupling element lies on an imaginary straight line.

8. The antenna device as claimed in claim 7, wherein each of said right end portion of said radiating element and said left end portion of said coupling element is generally L-shaped,
said right end portion of said radiating element including a first leg that extends transversely from said intermediate portion of said radiating element away from said conductive strip, and a second leg that is disposed above the imaginary straight line,
said left end portion of said coupling element including a first leg that extends transversely from said intermediate portion of said coupling element away from said conductive strip, and a second leg that is disposed below said second leg of said right end portion of said radiating element.

9. The antenna device as claimed in claim 8, wherein said second leg of said right end portion of said radiating element and said second leg of said left end portion of said coupling element define a vertical distance therebetween that ranges from 0.5 millimeters to 3.0 millimeters.

10. The antenna device as claimed in claim 7, wherein each of said right end portion of said radiating element and said left end portion of said coupling element is generally L-shaped,
said right end portion of said radiating element including a first leg that extends transversely from said intermediate portion of said radiating element toward said conductive strip, and a second leg that is disposed below the imaginary straight line,
said left end portion of said coupling element including a first leg that extends transversely from said intermediate portion of said coupling element toward said conductive strip, and a second leg that is disposed below said second leg of said right end portion of said radiating element.

11. The antenna device as claimed in claim 7, wherein said right end portion of said radiating element extends transversely from said intermediate portion of said radiating element toward said conductive strip, and said left end portion of said coupling element extends transversely from said intermediate portion of said coupling element toward said conductive strip.

12. The antenna device as claimed in claim 11, wherein said right end portion of said radiating element and said left end portion of said coupling element define a horizontal distance therebetween that ranges from 0.5 millimeters to 3.0 millimeters.

13. The antenna device as claimed in claim 7, wherein said right end portion of said radiating element extends transversely from said intermediate portion of said radiating element away from said conductive strip, and said left end portion of said coupling element extends transversely from said intermediate portion of said coupling element away from said conductive strip.

14. The antenna device as claimed in claim 7, wherein said left end portion of said coupling element is generally L-shaped, said left end portion of said coupling element including a first leg that extends transversely from said intermediate portion of said coupling element toward said conductive strip, and a second leg that is generally hook-shape and that defines a recess,
said right end portion of said radiating element extending transversely from said intermediate portion of said radiating element toward said conductive strip into said recess in said second leg of said left end portion of said coupling element.

15. The antenna device as claimed in claim 14, wherein said right end portion of said radiating element and said second leg of said left end portion of said coupling element define a vertical distance therebetween that ranges from 0.5 millimeters to 3.0 millimeters.

16. The antenna device as claimed in claim 7, wherein said right end portion of said radiating element is generally L-shaped, said right end portion of said radiating element including a first leg that extends transversely from said intermediate portion of said radiating element toward said conductive strip, and a second leg that is generally hook-shaped and that defines a recess,
said left end portion of said coupling element extending transversely from said intermediate portion of said coupling element toward said conductive strip into said recess in said second leg of said right end portion of said radiating element.

17. The antenna device as claimed in claim 3, wherein said feeding element and said second leg of said left end portion of said coupling element define a horizontal distance therebetween that ranges from 0.5 millimeters to 3.0 millimeters.

18. The antenna device as claimed in claim 1, wherein the first frequency bandwidth is lower than the second frequency bandwidth.

19. The antenna device as claimed in claim 18, wherein the first frequency bandwidth is 2.4 GHz and the second frequency bandwidth is 5 GHz.

20. The antenna device as claimed in claim 1, wherein the first frequency bandwidth is higher than the second frequency bandwidth.
